(19) United States
(12) Patent Application Publication
(10) Pub. No.: US 2009/0210425 A1
(43) Pub. Date: Aug. 20, 2009

(54) Method for sending dynamic content and dynamic content delivery server

(75) Inventor: Jin Peng, Guangdong Province (CN)

Correspondence Address: WOLF GREENFIELD & SACKS, P.C., 600 ATLANTIC AVENUE, BOSTON, MA, 02210-2206, US

(73) Assignee: Huawei Technologies Co., Ltd., Shenzhen (CN)

(21) Appl. No.: 11/597,224

(22) PCT Filed: Jul. 25, 2006
(86) PCT No.: PCT/CN06/01838

§ 371 Date: Apr. 16, 2009

(30) Foreign Application Priority Data
Sep. 30, 2005 (CN) 200510105909.4

(51) Int. Cl. G06F 17/30; G06F 15/16

(52) U.S. Cl. 707/10; 707/100; 709/203; 707/E17.01; 707/E17.044

(57) ABSTRACT

A method for sending dynamic content and a dynamic content transmission server are disclosed. The method for sending dynamic content includes: storing an original dynamic content subscribed to by a user; creating and storing a corresponding relationship between the user and the subscribed original dynamic content; and obtaining the corresponding original dynamic content according to the corresponding relationship, and performing personalized processing on the original dynamic content, and sending the processed dynamic content to the user. This method can implement sending of personalized subscribed dynamic content.

### FIELD OF THE INVENTION

The present invention relates to dynamic content delivery based on the client/server architecture, and particularly to a method for sending dynamic content and a dynamic content delivery server.

### BACKGROUND OF THE INVENTION

Content subscription is an existing communication service in the communications network, e.g., subscribing to an electric map, etc. The network side will send corresponding content to a user terminal according to the subscription requirements of the user. The subscription mode is relatively simple in that it is a subscription in a static sense, i.e. the corresponding content is sent upon the initiating of a user's subscription request, or the corresponding content is sent to the user terminal periodically according to the user requirements.

Dynamic content delivery is a technique of providing personalized content to a mobile terminal user based on the mode of client/server architecture. In the practical application, there is such a requirement: in order to meet the real-time and personalization of the dynamic content delivery, when the server sends dynamic content subscribed by a user, the original content subscribed by the user has to be processed in a personalized manner according to the present information of the user, e.g. the user parameters, the user location, the online state, etc., and then transmitted to the user.

However, there is no corresponding operation criterion specified to the method for storing and sending dynamic content.

### SUMMARY OF THE INVENTION

The method for sending dynamic content according to an embodiment of the present invention includes:

storing an original dynamic content subscribed by a user;

creating and storing a corresponding relationship between the user and the subscribed original dynamic content; and

obtaining the corresponding original dynamic content according to the corresponding relationship, and performing personalized processing on the original dynamic content, and sending the processed dynamic content to the user.

According to the embodiments of the present invention, when a user terminal requests to send the dynamic content, the dynamic content delivery server performs personalized processing on the content subscribed by the user according to the current configuration and the status of the user terminal, and sends the processed content to the user, implementing personalization and practicability of dynamic content delivery.

### BRIEF DESCRIPTION OF THE DRAWINGS

The accompanying drawings, which are incorporated in and constitute a part of this specification, illustrate the invention and together with the description, and serve to explain the principles of the invention.

FIG. 1 is a flowchart of the method for sending dynamic content according to an embodiment of the present invention.

FIG. 2 is a diagram illustrating the architecture of the dynamic content delivery server according to an embodiment of the present invention.

### DETAILED DESCRIPTION OF THE INVENTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

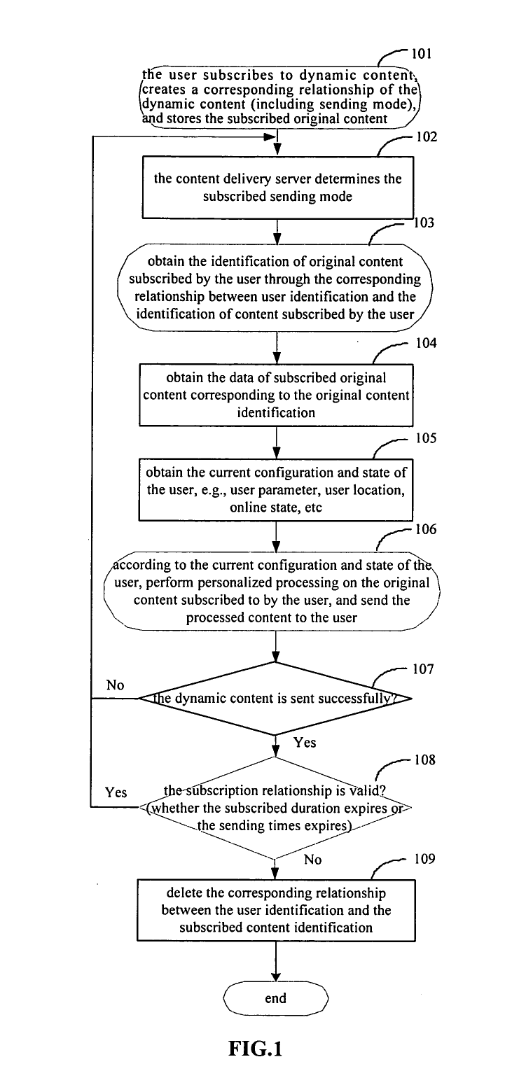

FIG. 1 is a flowchart of the method for sending dynamic content according to an embodiment of the present invention, including the processes as follows.

In step 101, according to the original dynamic content subscribed to a dynamic content delivery server by a user, a dynamic content delivery server creates a corresponding relationship of the dynamic content. The created corresponding relationship includes at least the corresponding relationship between the user identification (e.g., IMSI, International Mobile Subscriber Identity) and the identification of the original dynamic content subscribed by the user. The created corresponding relationship may also include sending mode information of dynamic content set by the user or the server, e.g. the periodical sending mode by the dynamic content delivery server or the sending mode of dynamic message content upon the user requests.

The dynamic content delivery server stores original dynamic contents subscribed by all users, i.e., contents without personalized processing. Wherein, each piece of original dynamic content corresponds to a unique original dynamic content identification, to identify different original dynamic content.

In step 102, according to the corresponding relationship of the dynamic content, the dynamic content delivery server determines the subscribed sending mode, which may be a periodical sending mode or a sending mode upon the user requests set by the dynamic content delivery server or the user.

In step 103, the dynamic content delivery server obtains the identification of subscribed original dynamic content by the user, according to the user identification (e.g., IMSI, International Mobile Subscriber Identity) and the corresponding relationship between the user identification and the identification of subscribed original dynamic content by the user.

In step 104, the dynamic content delivery server obtains the data of originally subscribed dynamic content corresponding to the original dynamic content identification, according to the original dynamic content identification.

In step 105, the dynamic content delivery server obtains the current configuration information and state information of the user, e.g., obtains the current location of the user from the location server, obtains the current presence information from the presence server, etc.

In step 106, the dynamic content delivery server performs a personalized processing on the subscribed original dynamic content by the user, according to the current configuration information and state information of the user, and sends the processed dynamic content to the user.

In step 107, if the processed dynamic content is not sent to the user successfully due to reasons, e.g., the user is unreachable, etc., the procedure goes to the step 102, so that the dynamic content is re-personalized and sent to the user according to the subscribed sending mode; if the dynamic content is sent successfully, the procedure goes to the following processes.

In step 108, whether the user subscription relationship is valid, e.g. whether the subscribed duration by the user expires or the subscribed sending times by the user expires, is determined; if not, the procedure goes to step 102, where the dynamic content is re-sent according to the subscribed sending mode; if the subscribed duration by the user expires or the subscribed sending times by the user expires, the procedure goes to step 109.

In step 109, the corresponding relationship between the user identification and the identification of the subscribed original dynamic content is deleted; if necessary, the original dynamic contents which are stored in the dynamic content delivery server and not being subscribed by any user are deleted; and the sending flow of dynamic content ends.

In the above procedure, the step 105 doesn't have to be performed after the step 104, but before the step 106. For example, for the sending mode upon user request set by the user, the dynamic content delivery server after receiving the user request obtains the current configuration information and state information of the user immediately, e.g., obtains the current location of the user from the location server, obtains the current presence information from the presence server, etc. In another example, if the periodical sending mode is adapted, when the set sending duration expires, the dynamic content delivery server obtains the current configuration information and state information of the user, e.g., obtains the current location of the user from the location server, obtains the current presence information from the presence server, etc.

In the above method according to an embodiment of the present invention, the corresponding relationship between the user and the subscribed original dynamic content may be stored in a corresponding relationship table, in which each record stores at least one user identification and the identification of the subscribed original dynamic content by the user, wherein each original dynamic content identification corresponds to an original dynamic content uniquely.

In the above method according to an embodiment of the present invention, the dynamic content delivery server may allocate multiple individual storage spaces to each user. Each individual storage space stores a corresponding relationship between the user identification and the identification of the subscribed original dynamic content by the user, wherein each original dynamic content identification corresponds to an original dynamic content uniquely.

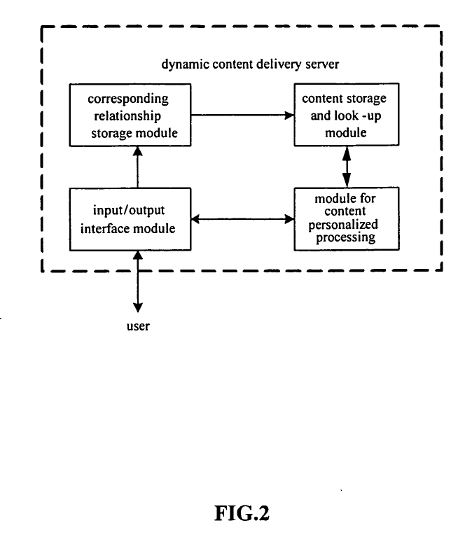

FIG. 2 is a diagram illustrating the architecture of the dynamic content delivery server according to an embodiment of the present invention, including: an input/output interface module, a corresponding relationship storage module, a content storage and look-up module, and a module for content personalized processing, wherein the function of each module is as follows.

The input/output interface module is adapted to receive an original dynamic content subscription request originated by a user terminal, and output the processed dynamic content to the user terminal. The input/output interface module is further provided with a connection interface connected with a network entity, from which the current configuration information and state information of the user is obtained and sent to the module for content personalized processing.

The corresponding relationship storage module is adapted to establish and store the corresponding relationship between the user and the subscribed original dynamic content according to the subscribed original dynamic content by the user terminal. The corresponding relationship storage module includes multiple individual storage spaces, and each individual storage space stores a corresponding relationship between the user identification and the identification of the subscribed original dynamic content by the user. The corresponding relationship storage module further stores the corresponding relationship in a form of relationship table, wherein each record of the table stores one user identification and the identification of the subscribed original dynamic content by the user.

The content storage and look-up module is adapted to store original dynamic contents, i.e., contents without personalized processing, subscribed to by all users.

The module for content personalized processing is adapted to perform personalized processing on the subscribed original dynamic contents by the users according to the obtained current configuration information and state information of the user terminal, and transmitted the dynamic content processed in a personalized manner to the user terminal through the input/output interface module.

After the user terminal sends a dynamic content subscription request, the input/output interface module of the dynamic content delivery server receives the subscription request and sends the subscription request to the module for content personalized processing. The module for content personalized processing determines the sending mode of dynamic content according to the received subscription request, e.g., the sending mode upon the user request or the periodical sending mode. When the set duration expires or the user request is sent immediately, the module for content personalized processing sends the user identification to the content storage and look-up module. The content storage and look-up module sends the received user identification to the corresponding relationship storage module, in which the identification of the subscribed original dynamic content by the user corresponding to the user identification is queried and obtained, searches out the original dynamic content according to the obtained the original dynamic content identification, and sends the original dynamic content to the module for content personalized processing; the module for content personalized processing obtains the current configuration information and state information of the user through the input/output interface module, performs personalized processing on the obtained original dynamic content, and sends the dynamic content processed in a personalized manner to the user terminal through the input/output interface module.

The method of the present invention will be described in detail in combination with the following detailed embodiments.

Embodiment one: the dynamic content delivery server sends the dynamic electric map to the user in periodical sending mode.

To obtain the dynamic electric map periodically, the user firstly needs to subscribe to the electric map and choose the sending mode as periodical sending mode by the dynamic content delivery server. Taking an example that the user subscribes to a “map of Shenzhen city”, the procedure of user subscription is described as follows.

Firstly, the corresponding relationship between the user and the subscribed original dynamic content upon a subscription request from the user is determined; for example, add a record in the corresponding relationship table between the user identification and the identification of the original dynamic content, wherein the user identification is IMSI code of the user, IMS_user1, and the identification of the original dynamic content is identification of the subscribed “map of shenzhen city” by the user, Add_shenzhen.

Then, a sending mode is determined and necessary sending parameters are set upon the subscription request. Here, the user has chosen the sending mode as periodical sending mode by the dynamic content delivery server while subscribing, thus the relative parameters may be subscription duration and sending time interval, or sending times and sending time interval.

The dynamic content delivery server stores the subscribed original dynamic content by the user and creates a unique corresponding relationship between the identification of original dynamic content and the original dynamic content. Particularly, the dynamic content delivery server sets an identification header field for the stored original dynamic content, or stores a corresponding relationship table between the identification of original dynamic content and the storage address of the original dynamic content.

After the user subscription, the dynamic content delivery server begins to send the original dynamic content according to the subscription relationship. When the specified time interval expires, the dynamic content delivery server sends the “map of Shenzhen city” to the user with the IMSI code of IMSI_user1, the particular sending procedure is described as follows.

In step 1-1, the content storage and look-up module in the dynamic content delivery server searches for the identification of subscribed “map of Shenzhen city” by the user with the user identification of IMSI_user1, Add_shenzhen in the corresponding relationship table between the user identification and the original dynamic content identification;

In step 1-2, the content storage and look-up module in the dynamic content delivery server searches for the data of “map of Shenzhen city” according to the searched “map of Shenzhen city” identification of Add_shenzhen, and sends the data together with the user IMSI_user1 code to the module for content personalized processing.

In step 1-3, after receiving the data of “map of Shenzhen city”, the module for content personalized processing, according to the searched user IMSI_user1 code, obtains the current location of the user, Longgang district of Shenzhen city, from the user location server through a connection interface via which the input/output interface module is connected with the user location server; obtains the system time, Greenwich Mean Time 10:00, from the system server through the connection interface via which the input/output interface module is connected with the user location server; and obtains the user local time, 18:00, in combination with the user location (time difference between Shenzhen and Greenwich Mean Time is 8 hours). The module for content personalized processing, according to the user IMSI_user1 code, obtains the current state of the user, driving, from the presence server through the connection interface via which the input/output interface module is connected with the presence server;

In step 1-4, the module for content personalized processing, according to the obtained current location, time and the state information of the user at step 1-3, performs personalized processing on the data of “map of Shenzhen city”, obtains the “road and transportation map of the Longgang district of Shenzhen city” after processing, and marks locations of main gas stations, restaurants and auto courts;

In step 1-5, the dynamic content delivery server sends the “road and transportation map of the Longgang district of Shenzhen city” with personalized processing to the user terminal through the input/output interface module.

If the user can't receive the “road and transportation map of the Longgang district of Shenzhen city” successfully due to reasons such as insufficient storage space of the user terminal, the dynamic content delivery server will send the dynamic “map of Shenzhen city” repeatedly at the specified time interval.

After the subscribed duration by the user expires or the subscribed sending times by the user expires, the corresponding relationship storage module deletes the record which includes the corresponding relationship between the user identification of IMSI_user1 and the “map of Shenzhen city” identification of Add_shenzhen.

Original contents, which are not subscribed by all users any more, are deleted from the content storage and look-up unit, and will be stored in the content storage and look-up module when they are subscribed by any user.

In the above procedures, the step 1-3 doesn't have to be performed after the step 1-2, but before the step 1-4.

Embodiment two: the dynamic content delivery server sends the dynamic electric map to the user upon the user request.

Similar to the embodiment one, the dynamic electric map needs to be subscribed by the user before sent. The subscription procedure in the embodiment two is similar to that of the embodiment one. To be different from the embodiment one, the chosen sending mode is a sending mode upon the user request, and the corresponding parameters are subscription duration or/and sending times.

The dynamic content delivery server begins to perform the personalized processing on the original dynamic content and sends the processed dynamic content according to the subscription relationship only after receiving the request of obtaining the “map of Shenzhen city” originated by the user terminal. The particular sending procedure is similar to the steps of the above embodiment one, will not be described here.

In conclusion, the present invention performs personalized processing on the subscribed original dynamic content by the user according to the current configuration information and state information of the user, according to a subscribed sending mode by the user or a sending mode set by the dynamic content delivery server, and send the processed dynamic content to the user, implementing personalization of the subscribed content, and improving service feelings of the user.

According to the embodiments of the present invention, a corresponding relationship of the user identification and the identification of the subscribed dynamic content is stored, therefore only one original dynamic content needs to be stored, implementing the original dynamic content share, and decreasing the storage resources for the original dynamic content.

According to the embodiments of the present invention, if the dynamic content has been sent to a user successfully or over, the stored corresponding information is deleted, i.e., the corresponding record is deleted when the subscription relationship is valid, which saves storage space and improves maintenance efficiency.

The foregoing description is just preferred embodiments of the present invention, and is not to be used to limit the protection scope thereof. Any modification, equivalent replacement and improvement based on the principle and spirit of the invention should be covered within the protection scope of the invention.

1. A method for sending dynamic content, comprising:
storing an original dynamic content subscribed to by a user;
creating and storing a corresponding relationship between the user and the subscribed original dynamic content; and
obtaining the corresponding original dynamic content according to the corresponding relationship, performing personalized processing on the original dynamic content, and sending the processed dynamic content to the user.

2. (canceled)

3. The method according to claim 1, wherein the corresponding relationship between the user and the subscribed original dynamic content further comprises: sending mode of the dynamic content set by the user or a server.

4. The method according to claim 1, wherein the process of storing an original dynamic content subscribed to by a user comprises the process of storing one unique identification corresponding to each original dynamic content; wherein the corresponding relationship between the user and the subscribed original dynamic content is stored in a corresponding relationship table; the corresponding relationship comprising: the user identification and identification of the subscribed original dynamic content by the user; and
the process of obtaining the original dynamic content comprises: searching in the corresponding relationship table, obtaining the corresponding original dynamic content identification according to the user identification, and obtaining the original dynamic content corresponding to the original dynamic content identification according to the original dynamic content identification.

5. The method according to claim 4, further comprising:
if the user subscription relationship is invalid, deleting the corresponding relationship between the user identification and the identification of subscribed original dynamic content by the user in the corresponding relationship table.

6. The method according to claim 1, wherein the process of storing an original dynamic content subscribed to by a user comprises the process of storing one unique identification corresponding to each original dynamic content; wherein the corresponding relationship between the user and the subscribed original dynamic content is stored with individual storage spaces; each of the individual storage spaces stores the user identification and the identification of subscribed original dynamic content by the user; and
when sending the subscribed dynamic content to the user, querying the corresponding individual storage space according to the user identification, obtaining the corresponding original dynamic content identification, and obtaining the original dynamic content corresponding to the original dynamic content identification from a content storage and look-up module.

7. The method according to claim 6, further comprising:
determining whether the user subscription relationship is valid; if the user subscription relationship is invalid, deleting the corresponding relationship between the user identification and the identification of the subscribed dynamic content by the user, stored in the individual storage space corresponding to the user.

8. The method according to claim 1, wherein the process of performing personalized processing on the original dynamic content is implemented according to the current configuration and state of the user.

9. The method according to claim 8, wherein the current configuration and state of the user are obtained from a system server, a presence server and/or a location server.

10. A dynamic content delivery server, comprising: relationship storage unit and the module for content personalized processing respectively; wherein
an input/output interface module, for receiving a dynamic content subscription request originated by a user terminal, and outputting subscribed dynamic content with personalized processing to the user;
a corresponding relationship storage module, for creating and storing corresponding relationship between the user and the subscribed original dynamic content according to the dynamic content subscribed to by the user;
a content storage and look-up module, for storing the original dynamic content, subscribed to by the user, without personalized processing, obtaining the identification of the subscribed original content by the user from the corresponding relationship storage module, searching for the original content data stored in the content storage and look-up module according to the obtained identification of original content; and
a module for content personalized processing, for performing personalized processing on the original dynamic content, subscribed to by the user, stored in the content storage and look-up module.

11. The dynamic content delivery server according to claim 10, wherein the corresponding relationship storage module is adapted to store the corresponding relationship table of the user identification and the identification of the subscribed original dynamic content by the user; and
when sending the subscribed dynamic content to the user, searching in the corresponding relationship table, obtaining the corresponding original dynamic content identification according to the user identification, and sending the original dynamic content corresponding to the original dynamic content identification searched in the content storage and look-up module to the module for content personalized processing to perform personalized processing.

12. The dynamic content delivery server according to claim 10, wherein the corresponding relationship storage module comprises individual storage spaces, which are adapted to store the user identification and the identification of the subscribed original dynamic content by the user; and
when sending the subscribed dynamic content to the user, searching in the corresponding individual storage space according to the user identification, obtaining the corresponding original dynamic content identification, and sending the original dynamic content corresponding to the original dynamic content identification searched from the content storage and look-up module to the module for content personalized processing to perform personalized processing.

13. The dynamic content delivery server according to claim 10, wherein the input/output interface module further comprises a connection interface connected with a network entity, the interface obtaining current configuration and state of the user from the network entity, and sends the current configuration and state of the user to the module for content personalized processing; the module for content personalized processing performs the personalized processing on the original dynamic content according to the current configuration and state of the user.

14. The dynamic content delivery server according to claim 11, wherein the input/output interface module further comprises a connection interface connected with a network entity, the interface obtaining current configuration and state of the user from the network entity, and sends the current configuration and state of the user to the module for content personalized processing; the module for content personalized processing performs the personalized processing on the original dynamic content according to the current configuration and state of the user.

15. The dynamic content delivery server according to claim 12, wherein the input/output interface module further comprises a connection interface connected with a network entity, the interface obtaining current configuration and state of the user from the network entity, and sends the current configuration and state of the user to the module for content personalized processing; the module for content personalized processing performs the personalized processing on the original dynamic content according to the current configuration and state of the user.
